(19) United States
(12) Patent Application Publication
(10) Pub. No.: US 2006/0182186 A1
(43) Pub. Date: Aug. 17, 2006

(54) Volume control device for digital signals

(75) Inventors: Daniel Schinkel, Enschede (NL); Adrianus Johannes Maria Van Tuijl, Eindhoven (NL); Petrus Antonius Cornelis Maria Nuijten, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/550,339

(22) PCT Filed: Mar. 24, 2004
(86) PCT No.: PCT/IB04/50324

§ 371 Date: Sep. 22, 2005

(30) Foreign Application Priority Data
Mar. 27, 2003 (EP) 03100799.0

(51) Int. Cl. H04B 14/04

(52) U.S. Cl. 375/243

(57) ABSTRACT

A digital volume control device comprises a logic unit for volume control of digital input signals. Successively supplied m-bits words with maximally k bits active, derived from the output signals of or supplied by a volume control (4) with a quantizer (5) element the filtered m-bits workds are passed, however, with only the j most significant active bits of these filtered signals. The noise shaper operates with a frequency that is a k/j-fold of the frequency by which the m-bits words are supplied. An up-sampler (3) is provided for operation frequency adjustment of the filtered m-bits words to the noise shaper. This operation frequency is at least a factor k/j greater than the sample rate of the digital input signals. The control signals for the logic unit are formed by the m-bits words passed by the quantizer.

The invention relates to a digital volume control device and particularly to a volume control device for digital audio signals, comprising a logic unit to which digital input signals to be controlled are supplied and which provides for volume controlled digital output signals, the volume control of said digital input signals being determined by control signals, derived from output signals of a volume control element.

The volume control element can have the form of a manually controlled device, as may be the case in audio apparatus, it can be part of an automatic volume control or a computer which provide for the output signals from which the control signals are derived.

On the current market various volume control devices for digital audio signals are available, sometimes implemented in software and executed on a digital signal processor or implemented in hardware, often integrated together with other signal processing blocks. In practice, digital volume control devices implemented in hardware have a logic unit in the form of a multiplier, in which the multiplication word-length is quite large. When, for example, pulse code modulated (PCM) audio input signals with a common word-length of 24 bits are applied and the volume of these audio input signals must be controlled in a range between about −83 dB and about +11.5 dB, a control signal must be applied of at least 18 bits in order to obtain a 2 dB resolution over the entire control range. To obtain a 1.5 dB resolution over the entire control range at least a 20-bits control signal is required. However, a multiplication of a 24-bits audio input signal with an 18 or 20-bits control signal requires a large and relatively expensive multiplier. Further, during volume transitions, i.e. the dynamic mode of the volume control device, even a resolution of about 1.5 dB is not sufficient to avoid audible ‘clicks’.

A digital volume control device as described in the opening is known from U.S. Pat. No. 6,405,092. The logic unit in said patent specification is, in a first embodiment, formed by a bit-shifter, whereas by means of control signals the supplied words may be bidirectionally shifted. This means that only a 6 dB resolution is obtained. To obtain a more fine resolution, for example 1.5 dB, in a further embodiment in said patent specification a multiplier is used with adders to add a number of shifted input words, while during volume transitions with 1.5 dB volume steps clicks will still be audible.

The purpose of the invention is to provide for a digital volume control device in which a large and expensive multiplier is avoided and a high resolution in volume control is obtained.

Therefore, according to the invention the digital volume control device as described in the opening paragraph is characterized in that the digital volume control device further comprises

conversion means for receiving the control signal in the form of a succession of m-bits words having k active bits at a first sample frequency and converting the control signal into an intermediate comprising a succession of m-bits words having j active bits at a second sample frequency at least k/j greater than the first sample frequency;

averaging means for generating an multiplied signal by multiplying the intermediate signal with the digital input signal and generating the output signal by averaging the multiplied signal.

Particularly, when the quantizer is designed to supply m-bits words with only the most significant active bit of the words supplied to the noise shaper, i.e. the case wherein j=1, the logic unit may be constituted by a simple shift register. In such a case, instead of a complicated multiplication, only a number of successive shift operations can be carried out. With a value j=2 or 3 simple multiplications in the logic unit are still necessary.

An advantage of the application of the low-pass filter is that audible clicks are avoided. During volume transitions a large number of volume steps, much smaller than for example the 1.5 dB volume steps occur. While in the stationary state for example 1.5 dB steps occur, in the dynamic state, i.e. during volume transitions, the low-pass filter introduces much smaller volume steps.

Often, in audio systems oversampled digital input signals are available. With, for example, a standard sample-rate for a CD-player of a value fₛ of about 44.1 kHz and because digital input signals in other parts of the audio system require a sample-rate of about 11 MHz, i.e. 256*fₛ, besides an amplitude-resolution a time-resolution may be possible. When the low-pass filter runs at a clock-frequency of 64*fₛ, the up-sampler can provide for words at a four times higher frequency, i.e. 256*fₛ. This means that during each four clock periods of the up-sampler one signal formed by a low-pass filtered signal and three signals consisting of only zero's are supplied to the noise shaper, so that by successively generating four multiplication factors in time consisting of powers of 2, an average multiplication can be obtained corresponding with a desired multiplication factor. A desired multiplication, corresponding with a fine volume control resolution, as is the case with complicated multipliers, is thus realized by only a number of successive shift operations without use of adders.

The invention does not only relate to a digital volume control device, but also to an audio apparatus comprising such a digital volume control device.

The invention will further be explained by the following description of some preferred embodiments and with reference to the accompanying drawings:

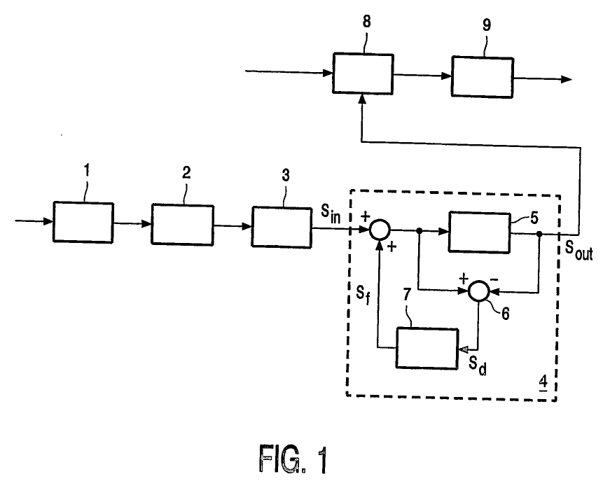

FIG. 1 shows a block diagram of an embodiment of a digital volume control according to the invention;

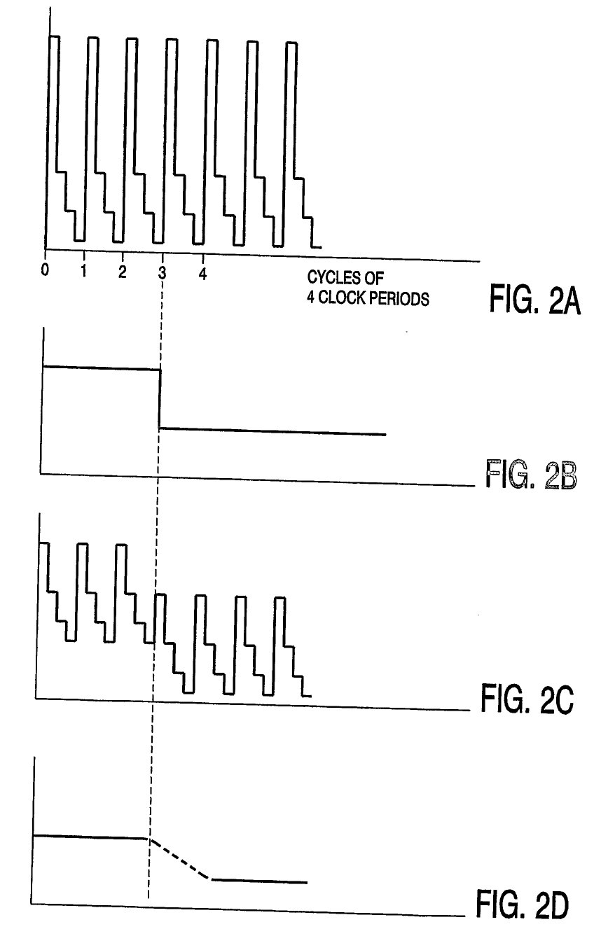

FIG. 2 shows diagrams to further elucidate the operation of this block diagram.

In the block diagram of FIG. 1 showing a volume control device for digital audio signals a dB-to-linear decoder is indicated with reference number 1. To this decoder input signals are supplied in the form of n-bits words coming from a hand operated volume control element for digital audio input signals and covering a predetermined volume range. When, for example, these input signals are formed by 6-bits words and cover a volume range of about 94.5 dB, from −83 to +11.5 dB, they have a resolution of about 1.5 dB. In the decoder 1 the n-bits words, covering a logarithmical scale, are decoded to output signals formed by m-bits words with m>>n, covering a linear scale. To maintain the resolution of 1.5 dB over at least the whole volume range in the present example, the output signals may be formed by 20-bits words, with k=4 bits (4 one's) maximally active.

00000000001101100000, corresponding with 58.7 dB

00000000010000000000 60.2 dB

00000000010011000001 61.7 dB

00000000010110100000 63.2 dB

00000000011011000000 64.7 dB

00000000100000000000 66.2 dB

In this and the following examples the above values are taken with reference to a 0 dB value. The real volume value must be diminished with a value of −83 dB.

The output signals of the decoder 1 are supplied to a low-pass filter 2. From the point of view of costs saving a first order IIR (infinite impulse response) filter is used. Nevertheless higher order IIR filters are acceptable.

To obtain slow volume changes, the low-pass filter 2 has a cut-off frequency of 3.5 Hz and is further so designed that, some time after the start of a volume transition, its output signal will always reach a value equal to that of its input signal. By this measure the output signal of the low-pass filter shall still contain words with, in the stationary state, only 4 bits active maximally. Not only IIR filter are applicable, but also FIR (finite impulse response) filters can be used. The length of such filters is dependent on the cut-off frequency. For low values of the cut-off frequency, as is the case in this embodiment, a relatively long filter, i.e. a filter with a large number of filter coefficients, must be used, which can be considered as a disadvantage.

Next, the output signals of the low-pass filter 2 are supplied to a pure up-sampler 3 wherein the volume gain is up-sampled with a factor 4. The up-sampler produces one sample equal to the input every 4^{th} clock period and the other clock periods samples with value zero. The up-sampling factor 4 is chosen in connection with the maximal number of active bits in the 20-bits words of the present example as will be clear after having explained the operation of the following stage, the noise shaper 4 to which the samples from the up-sampler are supplied.

The noise shaper 4 is formed by a quantizer 5 and a feed back loop 6 with a one clock cycle delay element 7 to feed back the difference between the input signal (Sᵢₙ+S_{f}) and the output signal (Sₒᵤₜ) of the quantizer, i.e. the error signal (S_{d}), to the input of the noise shaper (Sᵢₙ). The sum of the input signal of the noise shaper and the delayed error signal (S_{f}) will be used to feed the quantizer in the subsequent clock cycle. In this example, in the quantizer only the most significant active bit will be passed, while the other bits of the 20-bits words will be made zero. In the stationary state the operation of the noise shaper will be clear by looking to the signals Sᵢₙ, Sₒᵤₜ, S_{d}, and S_{f} in subsequent clock periods t₀, t₁, t₂ and t₃:

t₀ S_{f}=00000000000000000000

Sᵢₙ=00000000010011000001 (61.7 dB)

S_{f}+Sᵢₙ=00000000010011000001

Sₒᵤₜ=00000000010000000000

S_{d}=00000000000011000001

t₁ Sᵢₙ=00000000000000000000

S_{f}+Sᵢₙ=00000000000011000001

Sₒᵤₜ=00000000000010000000

S_{d}=00000000000001000001

t₂ Sᵢₙ=00000000000000000000

S_{f}+Sᵢₙ=00000000000001000001

Sₒᵤₜ=00000000000001000000

S_{d}=00000000000000000001

t₃ Sᵢₙ=00000000000000000000

S_{f}+Sᵢₙ=00000000000000000001

Sₒᵤₜ=00000000000000000001

S_{d}=00000000000000000000

Thus, after 4 clock periods the error signal is zero again and a next cycle of 4 clock periods can begin. The output signals of the noise shaper 4 in these 4 clock-periods are:

00000000010000000000

00000000000010000000

00000000000001000000

00000000000000000001

These output signals form the multiplication factors by means of which the volume of, for example, a 24-bits audio signal is controlled. These multiplication factors are generated with a frequency of, in this example, four times the frequency with which the digital input signals are supplied to the volume control device. In the stationary state this sequence of multiplication factors will be repeated and is illustrated in FIG. 2A. Instead of a multiplication of the 24-bits audio signal with a 20-bits multiplication factor, the multiplication is reduced to four multiplications with words having only one active bit. Instead of a logic unit in the form of a complicated multiplier, the logic unit can now be constituted by a simple shift register (barrel shifter) 8 with 20 shift positions in which successive shift operations are performed. With the multiplication factors as indicated in FIG. 2A and a digital input signal indicated in FIG. 2B, the output signal of the shift register is as indicated in FIG. 2C. It is emphasized that these figures only show a stationary state, i.e. a state wherein no volume transitions occur.

In the present example, only the 28 most significant bits of the shift register 8 are passed. By means of the low-pass filter 9, which may be carried out as a first order IIR filter, the output words of the bitshifter 8 are filtered and reduced again to 24-bits words. Higher order IIR filters or a FIR filter are possible too. When a FIR filter is applied, the output signal thereof is as indicated in FIG. 2D. When a 1^{st} order IIR filter is used some high frequency components will still be present.

In the stationary state the 4-cycle multiplication process is functionally equivalent to an up-sampling of the digital input signals from 64*fₛ to 256*fₛ, followed by a 4-taps FIR filter. Such a conceptual FIR filter does not suppress frequencies around 64*fₛ and 128*fₛ if its coefficients are arranged in this fashion with the largest values first, followed by decreasing values. Thus the output contains aliases around 64*fₛ and 128*fₛ, which are filtered when an additional IIR or FIR filter 9 is used.

In case of a volume transition, for example a 4.5 dB transition, from:

00000000001001100001 (55.5 dB) to

00000000010000000000 (60 dB),

the low-pass filter 2 realizes a gradual volume change in order to eliminate audible artefacts during the volume transition. This means that the filter output signal will be formed by a relatively long sequence of 24-bits words with values between the above two transition values, which words can have also more than 4 active bits. This means that, in general, each time after 4 clock periods, the error signal S_{d} will not be zero.

When at a certain moment, directly before the end value 00000000010000000000 is reached, the signal S_{f}+Sᵢₙ is 00000000001111111111, the signals Sᵢₙ, Sₒᵤₜ, S_{d}, and S_{f} in subsequent 4 clock periods will be:

t₀ S_{f}+Sᵢₙ=00000000001111111111

Sₒᵤₜ=00000000001000000000

S_{d}=00000000000111111111

t₁ Sᵢₙ=00000000000000000000

S_{f}+Sᵢₙ=00000000000111111111

sₒᵤₜ=00000000000100000000

S_{d}=00000000000011111111

t₂ Sᵢₙ=00000000000000000000

S_{f}+Sᵢₙ=00000000000011111111

Sₒᵤₜ=00000000000010000000

S_{d}=00000000000001111111

t₃ Sᵢₙ=000000000000000000000

S_{f}+Sᵢₙ=00000000000001111111

Sₒᵤₜ=00000000000001000000

S_{d}=00000000000000111111

and a new series of 4 clock periods will start, taking into account the error of the passed 4 clock periods:

t₀ Sᵢₙ=00000000010000000000

S_{f}+Sᵢₙ=00000000010000111111

Sₒᵤₜ=00000000010000000000

S_{d}=00000000000000111111

t₁ Sᵢₙ=00000000000000000000

S_{f}+Sᵢₙ=0000000000000111111

Sₒᵤₜ=00000000000000100000

S_{d}=00000000000000011111

t₂ Sᵢₙ=00000000000000000000

S_{f}+Sᵢₙ=00000000000000011111

Sₒᵤₜ=00000000000000010000

S_{d}=00000000000000001111

t₃ Sᵢₙ=00000000000000000000

S_{f}+Sᵢₙ=00000000000000001111

Sₒᵤₜ=00000000000000001000

S_{d}=00000000000000000111

Although the output of the low-pass filter 2 has reached its stationary state, there is still an error signal S_{d}. This error signal will disappear in the next four clock periods:

t₀ Sᵢₙ=00000000010000000000

S_{f}+Sᵢₙ=00000000010000000111

Sₒᵤₜ=00000000010000000000

S_{d}=00000000000000000111

t₁ Sᵢₙ=00000000000000000000

S_{f}+Sᵢₙ=00000000000000000111

Sₒᵤₜ=00000000000000000100

S_{d}=00000000000000000011

t₂ Sᵢₙ=00000000000000000000

S_{f}+Sᵢₙ=0000000000000000011

Sₒᵤₜ=0000000000000000010

S_{d}=00000000000000000001

t₃ Sᵢₙ=00000000000000000000

S_{f}+Sᵢₙ=00000000000000000001

Sₒᵤₜ=00000000000000000001

S_{d}=00000000000000000000

Now, the noise shaper has reached its stationary state. The output signals of the noise shaper are successively:

00000000001000000000

00000000000100000000

00000000000010000000

00000000000001000000

00000000010000000000

00000000000000100000

00000000000000010000

00000000000000001000

00000000010000000000

00000000000000000100

00000000000000000010.

00000000000000000001

and further as in the stationary state:

00000000010000000000

00000000000000000000

00000000000000000000

00000000000000000000

00000000010000000000

00000000000000000000

etc.

Again the multiplication factors are powers of 2, so that the volume transition is realized by only a time-sequence of shift operations.

In another case of a volume transition, for example a −4.5 dB transition, from:

00000000010000000000 to

00000000001001100001

the low-pass filter 2 again realizes a gradual volume change in order to eliminate audible artefacts during the volume transition. This means again that the filter output signal will be formed by a relatively long sequence of 24-bits words with values between the above two transition values, which words can have also more than 4 active bits.

When at a certain moment, directly before the end value 00000000001001100001 is reached, the signal S_{f}+Sᵢₙ is 00000000001001100010, the signals Sᵢₙ, Sₒᵤₜ, S_{d}, and S_{f} in subsequent 4 clock periods will be:

t₀ S_{f}+Sᵢₙ=00000000001001100010

Sₒᵤₜ=00000000001000000000

S_{d}=00000000000001100010

t₁ Sᵢₙ=00000000000000000000

S_{f}+Sᵢₙ=00000000000001100010

Sₒᵤₜ=00000000000001000000

S_{d}=00000000000000100010

t₂ Sᵢₙ=00000000000000000000

S_{f}+Sᵢₙ=00000000000000100010

Sₒᵤₜ=00000000000000100000

S_{d}=00000000000000000010

t₃ Sᵢₙ=00000000000000000000

S_{f}+Sᵢₙ=00000000000000000010

Sₒᵤₜ=00000000000000000010

S_{d}=00000000000000000000

and the error signal is zero again, while the stationary state is reached.

In the present example k is chosen 4, while 20-bits words with only the most significant bit of the supplied m-bits words is passed by the quantizer, the other bits being made zero, i.e. the case wherein j=1.

It will be clear that other values of k are possible. With the maximum number of active bits k=3, transitions in steps of about 2 dB will be possible with the following 20-bits control words:

00000000000100000000, corresponding with about 48 dB

00000000000101000100 50 dB

00000000000110010000 52 dB

00000000001000000000 54 dB

00000000001010001000 56 dB

In this case the up-sampler inserts between two successive 20-bits filtered words only two 20-bits words consisting of zero's, while the operation frequency of the noise shaper is 3 times the frequency with which the db-to-linear decoder 1 generates the 20-bits control signals. Other k-values will be possible depending on the desired step size of the volume control transitions.

In the preferred embodiment the output words of the noise shaper have only one active bit (j=1). Nevertheless two or more active bits will be possible (j=2 or more). With k=4 and j=2 in a cycle of 2 clock periods two active bits in the output words of the noise shaper imply 2 times a simple multiplication, to obtain an average multiplication corresponding with a desired multiplication of the digital input signals.

When the volume range is smaller than about 94 dB, the output words of the db-to-linear decoder can comprise less than 20 bits. When this volume range is larger than about 94 dB even more than 20 bits may be necessary, of course depending on the desired volume step size.

This type of volume control is applicable when a volume control implemented in hardware is needed. A clock frequency of at least k/j times the input sample rate (with k and j as defined above) is required for its operation. Possible application areas include sigma-delta D/A converters and digital audio-amplifiers, because the devices use oversampled signals and often lack a signal processing core with a multiplier. The dynamic volume control does not need a multiplier and can be integrated with very few hardware elements and thus low chip-area. The volume control can handle all common types of current signal formats, such as signals coming from a CD-, DVD- or SACD source, provided that the available clock frequency is high enough.

Although in the embodiments discussed comprise a noise-shaper, it will be clear to a person skilled in the art that other bit-stream converters, such as sigma-delta modulators may be used instead.

1. A digital volume control device to which a digital input signal to be controlled is supplied which provides for a volume controlled digital output signal, the volume control of said digital input signal being determined by a control input signal, characterized in that the digital volume control device further comprises:
conversion means for receiving the control signal in the form of a succession of m-bits words having k active bits at a first sample frequency and converting the control signal into an intermediate comprising a succession of m-bits words having j active bits at a second sample frequency at least k/j greater than the first sample frequency;
averaging means for generating an multiplied signal by multiplying the intermediate signal with the digital input signal and generating the output signal by averaging the multiplied signal.

2. A digital volume control device as claimed in claim 1, characterized in that the conversion means comprises an up-sampler for up-sampling of the control signal and a bit-stream converter for converting the up-sampled control signal into the intermediate signal.

3. A digital volume control device as claimed in claim 2, characterized in that the bit-stream converter is a noise-shaper having a combiner for generating an m-bit combination signal by combining the control signal with an m-bit error signal, a quantizer for generating the intermediate signal by passing-on only the j most significant bits of the combination signal setting the remaining bits to zero, and a feed back loop for generating the error signal out of the quantizer errors.

4. A digital volume control device as claimed in claim 1, characterized in that j=1, whereas the averaging means comprises a shift register for multiplying the intermediate signal with the digital input signal.

5. A digital volume control device as claimed in claim 1, characterized in that the conversion means comprises a low-pass filter is provided for filtering the control signal before up-sampling.

6. A digital volume control device as claimed in claim 5, characterized in that the low-pass filter is an infinite impulse response filter.

7. A digital volume control device as claimed in claim 1, characterized in that the averaging means comprise a low-pass output filter.

8. A digital volume control device as claimed in claim 7, characterized in that the low-pass output filter is a infinite impulse response filter.

9. A digital volume control device as claimed in claim 7, characterized in that an up-sampler is provided for up-sampling the digital input signal with a factor k/j, and the low-pass output filter is formed by a finite impulse response filter having k/j taps.

10. A digital volume control device as claimed in claim 1, characterized in that a dB-to-linear decoder is provided for generating the control signal in dependence upon an n-bit logarithmic control signal.

11. A digital volume control device as claimed in claim 10, characterized in that the output signal of the volume device covers a range of about 94 dB, whereas n=6, m=20, and k=4.

12. An audio apparatus comprising a digital volume control device according claim 1.
